(19) United States
(12) Patent Application Publication
(10) Pub. No.: US 2024/0066842 A1
(43) Pub. Date: Feb. 29, 2024

(54) LAYERED SHEET FOR INTERIOR MATERIAL OF A VEHICLE AND A METHOD FOR MANUFACTURING THE SAME

(71) Applicants: HYUNDAI MOTOR COMPANY, Seoul (KR); KIA CORPORATION, Seoul (KR); SEOYON E-HWA CO., LTD., Anyang-si (KR); HANWHA ADVANCED MATERIALS CORPORATION, Seoul (KR)

(72) Inventors: Eunju Noh, Hwaseong-si (KR); Insoo Han, Uiwang-si (KR); Youngchan Oh, Anyang-si (KR); Eunjoo Kong, Uiwang-si (KR); Jongtaek Na, Sejong-si (KR); Jebeom Yeon, Cheongju-si (KR); Minhyuk Kim, Sejong-si (KR)

(73) Assignees: HYUNDAI MOTOR COMPANY, Seoul (KR); KIA CORPORATION, Seoul (KR); SEOYON E-HWA CO., LTD., Anyang-si (KR); HANWHA ADVANCED MATERIALS CORPORATION, Seoul (KR)

(21) Appl. No.: 18/233,509

(22) Filed: Aug. 14, 2023

(30) Foreign Application Priority Data
Aug. 23, 2022 (KR) 10-2022-0105591

(51) Int. Cl. B32B 27/06; B32B 5/18; B32B 7/12; B32B 27/22; B32B 27/30; B32B 37/24

(52) U.S. Cl. CPC B32B 27/065; B32B 5/18; B32B 7/12; B32B 27/22; B32B 27/304; B32B 37/24; B32B 2037/243; B32B 2255/10; B32B 2255/26; B32B 2255/28; B32B 2266/025; B32B 2307/536; B32B 2307/54; B32B 2307/5825; B32B 2307/7376; B32B 2327/06; B32B 2375/00; B32B 2605/003

(57) ABSTRACT

A layered sheet for interior material of vehicles and a method for manufacturing the same are disclosed. To improve both emotional quality and molding quality, the layered sheet includes: a skin layer including a polyurethane (PU) and a polyvinyl chloride (PVC) sheet layer disposed under the PU layer; and a base layer disposed under the PVC sheet layer. The base layer includes thermoplastic olefin (TPO), PU foam, or soft polypropylene (S-PP) foam.

### CROSS-REFERENCE TO RELATED APPLICATION(S)

This application claims the benefit of and priority to Korean Patent Application No. 10-2022-0105591, filed on Aug. 23, 2022 in the Korean Intellectual Property Office, the disclosure of which is incorporated herein by reference.

### BACKGROUND

### Technical Field

The present disclosure relates to a layered sheet for interior material of vehicles. More particularly, the present disclosure relates to a layered sheet for interior material of vehicles having improved molding quality and emotional quality simultaneously. Additionally, the present disclosure relates to a method for manufacturing the same.

### Background Art

The statements in this section merely provide background information related to the present disclosure and may not constitute prior art.

Interior materials applied to vehicles are materials that drivers and passengers directly touch and come in contact with. Various materials such as plastic resins and natural leathers have been used to satisfy the needs of customers and meet their decorative requirements as well as ensuring the materials' functional aspects.

Particularly, with the recent enhancement in convenience and habitability of vehicles, customer demand for high aesthetic and emotional quality is increasing. Accordingly, the application of various soft materials, such as fabric, artificial leather, and natural leather as interior materials, tend to increase instead of common plastic materials.

Among these materials, artificial leather is a material that customers directly touch and come into contact with while driving their vehicles. Some required properties for interior materials are high emotional quality, combustibility, light fastness, durability, long-term aging, and the function of decorating the interior of vehicles. In addition, with the advent of electric vehicles (E/V) and the autonomous vehicle era, public perception of vehicles has changed from a simple means of transportation into a living space. As a result, the demand for high emotional quality and aesthetic quality has increased.

### SUMMARY

An aspect of the disclosure is to maintain and improve emotional quality by modifying the composition and structure of conventional artificial leather. Another aspect of the disclosure is to improve molding quality by applying in-mold grain (IMG) molding thereto.

Additional aspects of the disclosure are set forth in part in the description which follows and, in part, should be apparent from the description, or may be learned by practice of the disclosure.

In accordance with an aspect of the disclosure, a layered sheet for interior material of vehicles includes a skin layer having a polyurethane (PU) layer and a polyvinyl chloride (PVC) sheet layer disposed under the PU layer. The layered sheet further includes a base layer disposed under the skin layer. The base layer includes thermoplastic olefin (TPO), polyurethane (PU) foam, or soft-polypropylene (S-PP) foam.

A layered sheet for interior material of vehicles, according to another embodiment of the present disclosure, may further include a surface-treated layer on the PU layer.

A layered sheet for interior material of vehicles, according to another embodiment of the present disclosure, may further include a backside-treated layer between the skin layer and the base layer.

A layered sheet for interior material of vehicles, according to another embodiment of the present disclosure, may further include a bond layer between the backside-treated layer and the base layer.

A layered sheet for interior material of vehicles, according to another embodiment of the present disclosure, may further include a primer layer under the base layer.

In a layered sheet for interior material of vehicles, according to another embodiment of the present disclosure, the PU layer may have a thickness in a range of 0.03 to 0.2 millimeters (mm).

In a layered sheet for interior material of vehicles, according to another embodiment of the present disclosure, the PVC sheet layer may have a thickness in a range of 0.2 to 0.5 mm.

In a layered sheet for interior material of vehicles, according to another embodiment of the present disclosure, the skin layer may have a Shore A hardness in a range of 70 to 80.

In a layered sheet for interior material of vehicles, according to another embodiment of the present disclosure, the skin layer may have a tensile strength in a range of 150 to 250 kilogram-force per square centimeter (kgf/cm²).

In a layered sheet for interior material of vehicles, according to another embodiment of the present disclosure, the skin layer may have a tensile elongation at a break point of 250% or more.

In a layered sheet for interior material of vehicles, according to another embodiment of the present disclosure, the layered sheet may have a Shore C hardness in a range of 55 to 65.

In a layered sheet for interior material of vehicles, according to another embodiment of the present disclosure, the layered sheet may have a tensile strength in a range of 35 to 45 kgf/cm².

In a layered sheet for interior material of vehicles, according to another embodiment of the present disclosure, the layered sheet may have a tensile elongation at a break point of 200% or more.

In accordance with another aspect of the present disclosure to solve the above-described problems, a method for manufacturing a layered sheet for interior material of vehicles includes forming a skin layer by preparing a polyvinyl chloride (PVC) sheet layer in the form of a film by blending a PVC resin with a plasticizer at a rate in a range of 50 to 100 parts per hundred resin (phr). The method further includes forming the skin layer by forming a polyurethane (PU) layer by diluting a PU resin with a dimethylformamide (DMF)-free solvent at a rate in a range of 30 to 70 phr and coating the PVC sheet layer with the diluted PU resin.

A method for manufacturing a layered sheet for interior material of vehicles, according to another embodiment of the present disclosure, may further include conducting surface treatment on an upper surface of the skin layer.

A method for manufacturing a layered sheet for interior material of vehicles, according to another embodiment of the present disclosure, may further include conducting backside treatment on a lower surface of the skin layer.

A method for manufacturing a layered sheet for interior material of vehicles, according to another embodiment of the present disclosure, may further include conducting primer treatment on a lower surface of a base layer disposed under the skin layer.

A method for manufacturing a layered sheet for interior material of vehicles, according to another embodiment of the present disclosure, may further include conducting bond treatment on the upper surface of the base layer.

A method for manufacturing a layered sheet for interior material of vehicles, according to another embodiment of the present disclosure, may further include laminating the layers.

In a method for manufacturing a layered sheet for interior material of vehicles, according to another embodiment of the present disclosure, the plasticizer may include a phthalate-based compound and a non-phthalate-based compound.

In a method for manufacturing a layered sheet for interior material of vehicles, according to another embodiment of the present disclosure, the phthalate-based compound may include dioctyl phthalate (DOP), diisodecyl phthalate (DIDP), or diisononyl phthalate (DINP).

In a method for manufacturing a layered sheet for interior material of vehicles, according to another embodiment of the present disclosure, the non-phthalate-based compound may include tris(2-ethylhexyl) trimellitate (TOTM).

### BRIEF DESCRIPTION OF THE DRAWINGS

These and/or other aspects of the disclosure should become apparent and more readily appreciated from the following description of the embodiments, taken in conjunction with the accompanying drawings of which:

FIG. 1 is a diagram illustrating a structure of a layered sheet for the interior material of vehicles of Example 1.

FIG. 2 is a diagram illustrating a structure of a layered sheet for the interior material of vehicles of Example 2.

FIG. 3 is a photograph showing an overstretch burst phenomenon.

FIG. 4 is a photograph showing an edge whitening phenomenon.

FIG. 5 is a photograph showing insufficient embossing transferability.

FIG. 6 shows photographs of deep drawability and embossing transferability of Example 1 and Comparative Example 2.

FIG. 7 is a flowchart of a process of manufacturing a layered sheet for the interior material of vehicles in an embodiment of the present disclosure.

### DETAILED DESCRIPTION

Reference is now made in detail to the embodiments of the disclosure, examples of which are illustrated in the accompanying drawings, wherein like reference numerals refer to like elements throughout. However, the present disclosure may be embodied in many different forms and should not be construed as being limited to the embodiments set forth herein. Rather, these embodiments are provided so that this disclosure is thorough and complete, and should fully convey the scope of the disclosure to those having ordinary skill in the art.

The terms used herein are merely used to describe particular embodiments. Thus, an expression used in the singular encompasses the expression of the plural, unless it has a clearly different meaning in the context. In addition, it is to be understood that the terms such as “including” or “having” are intended to indicate the existence of features, steps, functions, components, or combinations thereof disclosed in the specification, and are not intended to preclude the possibility that one or more other features, steps, functions, components, or combinations thereof may exist or may be added.

Unless otherwise defined, all terms used herein have the same meaning as those commonly understood by one of ordinary skill in the art to which this disclosure belongs. Thus, these terms should not be interpreted in an idealized or overly formal sense unless expressly so defined herein. As used herein, the singular forms are intended to include the plural forms as well, unless the context clearly indicates otherwise.

In addition, the terms “about,” “substantially,” and the like used throughout the specification mean that when a natural manufacturing and substance allowable error are suggested, such an allowable error corresponds to a value or is similar to the value. Additionally, such values are intended for the sake of clear understanding of the present disclosure or to prevent an unconscious infringer from illegally using the disclosure of the present disclosure. The embodiments described in the specification and shown in the drawings are only illustrative and are not intended to represent all aspects of the disclosure, such that various modifications may be made without departing from the spirit of the disclosure.

In addition, the terms used in the present disclosure are merely used to describe embodiments and are not intended to limit the present disclosure. An expression used in the singular encompasses the expression of the plural unless it has a clearly different meaning in the context.

Also, an order of operations performed by the methods according to the disclosure may be changed unless there is a particular description about the order of operations.

Hereinafter, a layered sheet for interior material of vehicles and a method for manufacturing the same according to an embodiment are described in detail.

Artificial leather applied to interior materials of vehicles may have a complex structure including a skin layer formed of a resin such as polyvinyl chloride (PVC), polyurethane (PU), and thermoplastic olefin (TPO) polymer. The complex structure may also include a basic layer formed of polyester, nylon woven fiber, or polypropylene (PP) foam. However, it is difficult to apply common in-mold grain (IMG) molding to these materials because there are limits to obtaining molding quality of interior materials using PVC and PU skin layers due to low post-processing efficiency while high emotional quality is obtained thereby. In the case of TPO skin layer, there are limits to acquiring emotional quality. Additionally, there are also limits to obtaining molding quality using polyester and nylon woven fiber layers as a base layer due to their low elongation properties.

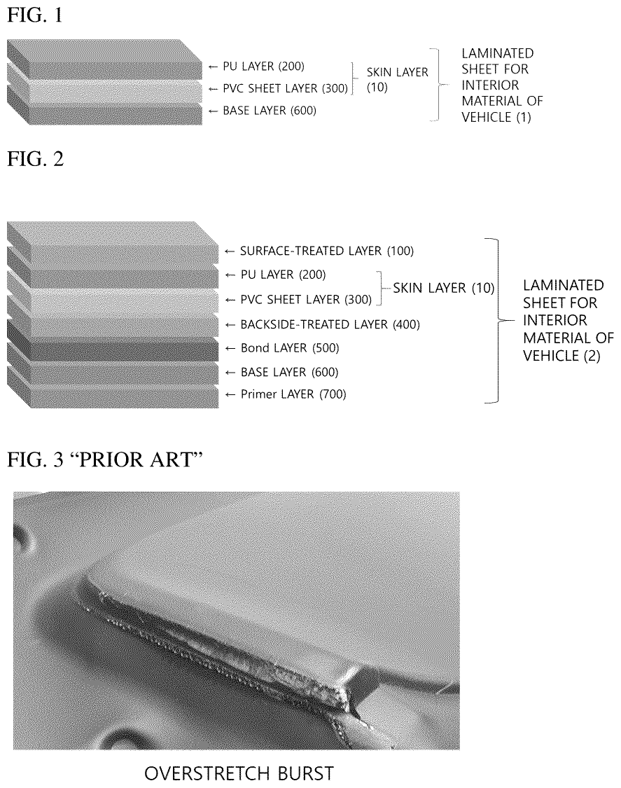

Thus, referring to FIGS. 1-2, a layered sheet for interior material of vehicles, according to an embodiment of the present disclosure, may include a skin layer 10. The skin layer 10 includes a polyurethane (PU) layer 200 and a polyvinyl chloride (PVC) sheet layer 300 disposed under the PU layer 200. The layered sheet may further include a base layer 600 disposed under the skin layer 10. The base layer 600 includes thermoplastic olefin (TPO), polyurethane foam (PU foam), or soft polypropylene foam (S-PP foam).

According to the present disclosure, high emotional quality may be maintained by using the PU layer 200 in the skin layer 10 while acquiring molding quality by adding the separately reformed PVC sheet layer 300 thereto. Furthermore, a high degree of freedom in molding may be obtained because the composition and thickness of the skin layer 10 are easily adjusted in accordance with a shape of a molded product. In addition, emotional quality may be maximized by forming the base layer 600 using the S-PP foam, TPO, or PU foam having a superior cushion feeling to that of conventional PP foam.

In addition, referring to FIG. 2, a layered sheet for interior material of vehicles, according to another embodiment of the present disclosure, may further include a surface-treated layer 100 on the PU layer 200.

In addition, referring to FIG. 2, a layered sheet for interior material of vehicles, according to another embodiment of the present disclosure, may further include a backside-treated layer 400 between the skin layer 10 and the base layer 600.

In addition, referring to FIG. 2, a layered sheet for interior material of vehicles, according to another embodiment of the present disclosure, may further include a bond layer 500 between the backside-treated layer 400 and the base layer 600.

In addition, referring to FIG. 2, a layered sheet for interior material of vehicles, according to another embodiment of the present disclosure, may further include a primer layer 700 under the base layer 600.

In addition, in a layered sheet for interior material of vehicles, according to another embodiment of the present disclosure, the PU layer 200 may be formed by coating a polyurethane resin diluted in dimethylformamide (DMF)-free solvent at a rate in a range of 30 to 70 parts per hundred resin (phr). The PU layer 200 of the skin layer 10 is formed by directly coating the polyurethane resin diluted in the DMF-free solvent or by using a release paper (RP) thereof.

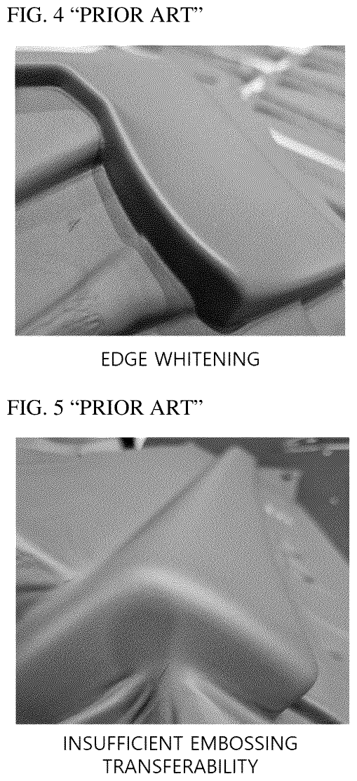

In a layered sheet for the interior material of vehicles, according to another embodiment of the present disclosure, a thickness of the PU layer 200 may be in a range from 0.03 to 0.2 millimeters (mm). As shown in FIGS. 3 and 4, when the thickness of the PU layer 200 is less than 0.03 mm, overstretch burst and edge whitening phenomena occur. When the thickness exceeds 0.2 mm, embossing transferability is insufficient, as shown in FIG. 5.

In addition, in a layered sheet for interior material of vehicles, according to another embodiment of the present disclosure, the PVC sheet layer 300 is formed in the form of a film by blending a PVC resin and a plasticizer at a rate in a range of 50 to 100 phr. The PVC sheet layer 300 of the skin layer 10 refers to a material prepared by blending a PCV resin with a plasticizer and calendaring or casting the mixture in the form of film or sheet by using raw materials to reform physical properties in accordance with crash pads and door trims for vehicles. With the content of the plasticizer less than 50 phr in the PVC resin, a Shore A hardness may be 90 or higher, causing the emotional quality (soft texture) to be inferior. In addition, with the content of the plasticizer exceeding 100 phr, the Shore A hardness may be 60 or less, causing over softening, which makes it difficult to control tension and thickness resulting in inferior processability.

In a layered sheet for interior material of vehicles, according to another embodiment of the present disclosure, a thickness of the PVC sheet layer 300 may be in a range from 0.2 to 0.5 mm. As shown in FIGS. 3 and 4 below, in the case where the thickness of the PVC sheet layer 300 is less than 0.2 mm, an overstretch burst phenomenon, an edge whitening phenomenon, and insufficient shape-realizing ability occur. In the case where the thickness of the PVC sheet layer 300 exceeds 0.5 mm, the cushion feeling is insufficient.

In a layered sheet for interior material of vehicles, according to another embodiment of the present disclosure, the plasticizer may include a phthalate-based compound and a non-phthalate-based compound. The phthalate-based compound may be dioctyl phthalate (DOP), diisodecyl phthalate (DIDP), diisononyl phthalate (DINP), and the like. The non-phthalate-based compound may be tris(2-ethylhexyl) trimellitate (TOTM). In the case where the plasticizer includes the above-described compounds, softness is provided to the PVC resin so that the skin layer 10 may have improved processability and physical properties. These properties include hardness, tensile strength, and tensile elongation at a break point.

In a layered sheet for interior material of vehicles, according to another embodiment of the present disclosure, the skin layer 10 may have a Shore A hardness in a range of 70 to 80, a tensile strength in a range of 150 to 250 kilogram-force per square centimeter (kgf/cm²), and a tensile elongation at a break point of 250% or more.

In a layered sheet for interior material of vehicles, according to another embodiment of the present disclosure, the layered sheet may have a Shore C hardness in a range of 55 to 65, a tensile strength in a range of 35 to 45 kgf/cm², and a tensile elongation at a break point of 200% or more.

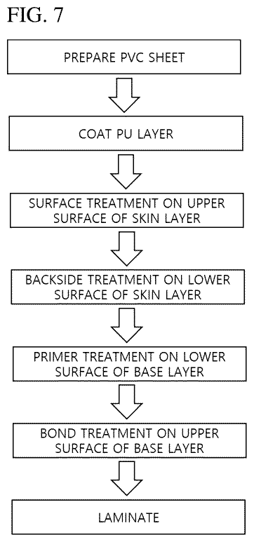

Referring to FIG. 7, a method for manufacturing a layered sheet for interior material of vehicles, according to an embodiment of the present disclosure, includes forming a skin layer by preparing a PVC sheet layer 300 in the form of film by blending a PVC resin with a plasticizer at a rate in a range of 50 to 100 phr. The method for forming the skin layer further includes forming a polyurethane (PU) layer 200 by diluting a PU resin with a dimethylformamide (DMF)-free solvent at a rate in a range of 30 to 70 phr and coating the PVC sheet layer with the diluted PU resin. The preparation of the PVC sheet layer 300 may be conducted using a calendaring or casting process.

In addition, the method for manufacturing a layered sheet for interior material of vehicles, according to an embodiment of the present disclosure, may further include conducting surface treatment on the upper surface of the skin layer 10. Thus, desired physical properties such as texture, color matching, surface properties, abrasion resistance, stain resistance, thermal resistance, and light resistance may be satisfied according to the use thereof.

In addition, the method for manufacturing a layered sheet for interior material of vehicles, according to an embodiment of the present disclosure, may further include conducting backside treatment on the lower surface of the skin layer 10. As a result, adhesion stability between the skin layer 10 and the base layer 600 may be obtained.

In addition, the method for manufacturing a layered sheet for interior material of vehicles, according to an embodiment of the present disclosure, may further include conducting primer treatment on the lower surface of the base layer 600. As a result, adhesion stability of the base layer 600 may be obtained.

In addition, the method for manufacturing a layered sheet for interior material of vehicles, according to an embodiment of the present disclosure, may further include conducting bond treatment on the upper surface of the base layer 600. As a result, adhesin stability between the skin layer 10 and the base layer 600 may be obtained.

In addition, the method for manufacturing a layered sheet for interior material of vehicles, according to an embodiment of the present disclosure, may further include conducting lamination. A flowchart of these steps of the manufacturing method is shown in FIG. 7.

Hereinafter, the present disclosure is described in more detail through examples. However, it is necessary to note that the following examples are only intended to illustrate the present disclosure in more detail and are not intended to limit the scope of the present disclosure. This is because the scope of the present disclosure is determined by matters described in the claims and able to be reasonably inferred therefrom.

### EXAMPLES

### Example 1: Layered Sheet for Interior Material of Vehicles (1)

Example 1 was prepared by forming a skin layer 10. The skin layer was formed by preparing a PVC sheet layer 300 in the form of a film using a PVC resin blended with a plasticizer at a rate in a range of 50 to 100 phr. The skin layer was further formed by coating the PVC sheet layer 300 with a PU layer 200 prepared by diluting a polyurethane resin using a dimethylformamide (DMF)-free solvent at a rate in a range of 30 to 70 phr. A structure thereof is shown in FIG. 1.

### Example 2: Layered Sheet for Interior Material of Vehicles (2)

A skin layer 10 was formed by preparing a PVC sheet layer 300 in the form of a film using a PVC resin blended with a plasticizer at a rate in a range of 50 to 100 phr. The skin layer was further formed by coating the PVC sheet layer 300 with a PU layer 200 prepared by diluting a polyurethane resin using a dimethylformamide (DMF)-free solvent at a rate in a range of 30 to 70 phr. Surface treatment was conducted on the upper surface of the formed skin layer 10 using urethane, acrylic, silicone, or the like. Backside treatment was conducted on the lower surface of the skin layer 10 using urethane, acrylic, or the like. Subsequently, primer treatment was performed on the lower surface of the base layer 600. After conducting bond treatment on the upper surface of the base layer 600, lamination was conducted to prepare Example 2, and a structure thereof is shown in FIG. 2.

### Comparative Examples 1 and 2: Layered Sheet for Interior Material of Vehicles

Layered sheets for interior material of vehicles were prepared in the same manner as in Example 1. However, the skin layer 10 contained PVC and PU and the base layer 600 contained fabric and PP foam (Comparative Example 1). Alternatively, the skin layer 10 contained TPO and the base layer 600 contained PP foam (Comparative Example 2).

Surface texture and cushion feeling of the products prepared in Example 1 and Comparative Examples 1 and 2 were evaluated and the results are shown in Table 1 below.

TABLE 1

| | | Comparative | Comparative | |
|---|---|---|---|---|
| — | | Example 1 | Example 2 | Example 1 |
| Skin layer | | PVC, PU | TPO Skin | PU layer/PVC |
| | | | | sheet layer |
| Base layer | | fabric, PP foam | PP foam | S-PP foam |
| Emotional | Surface | + | ∘ | ++ |
| quality | texture | | | |
| | Cushion | ∘ | ∘ | + |
| | feeling | | | |

* Mark: ∘ (fair), + (excellent), ++ (outstanding)

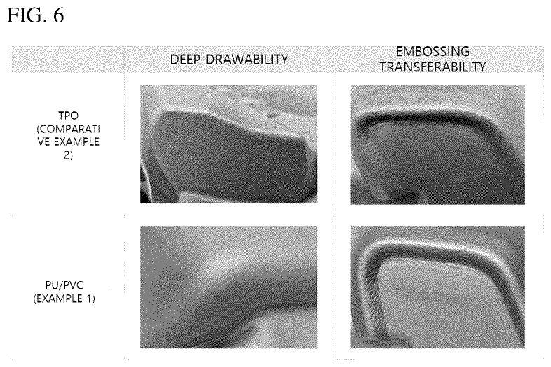

Referring to Table 1, the layered sheet of Example 1, having the PU layer/PVC sheet layer as the skin layer and S-PP foam as the base layer, had excellent surface texture and cushion feeling. The layered sheet of Comparative Example 1, having PVC and PU as the skin layer and fabric and PP foam as the base layer, had a fair cushion feeling. The layered sheet of Comparative Example 2, having TPO as the skin layer and PP foam as the base layer, had a fair surface texture and a fair cushion feeling. Referring to FIG. 6, it was confirmed that the layered sheet of Example 1, including the PU layer/PVC sheet layer as the skin layer, had in-mold grain (IMG) molding processability (deep drawability and embossing transferability) at the equal level to that of the layered sheet of Comparative Example 2 having TPO as the skin layer.

Method of Measuring Physical Properties: The thickness, specific gravity, hardness, 50% modulus, tensile strength, tensile elongation at a break point, and tear strength were measured according to MS220-14 standards.

### Experimental Example 1: Comparison of Physical Properties Between Types of Base Layer

Specimens including PP foam as the base layer (Comparative Example 2) and S-PP foam as the base layer (Example 1) were prepared with 20×2.5 T standard and physical properties thereof were measured. The results are shown in Table 2 below.

TABLE 2

| | | | |
|---|---|---|---|
| | | Common | S-PP foam |
| Item | Unit | PP foam | (TPO, PU foam) |

| | |
|---|---|
| Standard | 20 × 2.5 T |

| | | | |
|---|---|---|---|
| Thickness | mm | 2.51 | 2.55 |
| Density | g/cm³ | 0.050 | 0.0497 |
| Hardness | C-Type | 46 | 38 |
| Tensile strength L | kgf/cm² | 15.8 | 14.7 |
| Tensile strength W | | 9.8 | 9.4 |
| Room temperature | % | 400 | 421 |
| elongation L | | | |
| Room temperature | | 219 | 313 |
| elongation W | | | |
| Tear strength L | kgf/cm² | 5.1 | 4.3 |
| Tear strength W | | 7.4 | 5.9 |

Referring to Table 2, while the layered sheet of Comparative Example 2 had a hardness of 46, the layered sheet of Example 1 had a lower hardness of 38 than that of Comparative Example 2. Additionally, the room temperature elongations L (length) and W (width) of Example 1 were higher than those of Comparative Example 2. Therefore, it was confirmed that a case where the base layer contains soft polypropylene (S-PP) foam exhibits a superior cushion feeling to that of a case where the base layer contains common PP foam.

### Experimental Example 2: Measurement of Physical Property of Skin Layer and Layered Sheet of Example 2

Specimens of the skin layer and the layered sheet of Example 2 were prepared with 20×2.5 T standard and physical properties thereof were measured according to MS220-14 standards. The results are shown in Table 3 below.

TABLE 3

| | | | | Layered sheet of | |
|---|---|---|---|---|---|
| | | | Skin layer of | Example 2 (PU | |
| | | | Example 2 (PU | layer/PVC sheet | |
| | | | layer/PVC sheet | layer + | Test |
| Item | | Unit | layer) | S-PP foam) | method |
| Thickness | | mm | 0.52 | 3.03 | MS220-14 |
| Specific gravity | | — | 1.21 | — | |
| Hardness | | Shore “A” or | Shore | Shore | |
| | | Shore “C” | A 75.8 | C 61 | |
| 50% | Length | kgf/cm² | 65 | 21 | |
| Modulus | Width | | 65 | 18 | |
| Tensile | Length | kgf/cm² | 192 | 45 | |
| strength | Width | | 193 | 34 | |
| Tensile | Length | % | 277 | 308 | |
| elongation | Width | | 282 | 230 | |
| at break | | | | | |
| Tear | Length | kgf/mm | 6.17 | 1.86 | |
| strength | Width | | 5.41 | 5.41 | |

| | | | | |
|---|---|---|---|---|
| Hydrolysis resistance | — | No adhesion and | No adhesion and | Coating evaluation |

| | | |
|---|---|---|
| damage | damage | method |

* Coating evaluation method: 90 ± 2° C./95 ± 2% RH/168 hr

Referring to Table 3, it was confirmed that the skin layer, having the PU layer/PVC sheet layer of Example 2, had a Shore A hardness in a range of 70 to 80, a tensile strength in a range of 150 to 250 kgf/cm², and a tensile elongation at a break point of 250% or more. Also, it was confirmed that the layered sheet for interior material of vehicles of Example 2 had a Shore C hardness in a range of 55 to 65, a tensile strength in a range of 35 to 45 kgf/cm², and a tensile elongation at a break point of 200% or more. As a result, Example 2 indicates excellent emotional quality (surface texture and cushion feeling) and molding quality (deep drawability, embossing transferability, and high degree of freedom in molding).

According to the present disclosure, provided is a layered sheet for interior material of vehicles having excellent emotional quality and molding quality. Additionally, in-mold grain (IMG) molding is applicable by maintaining and improving emotional quality and molding quality.

Although embodiments of the disclosure have been shown and described, it would be appreciated by those having ordinary skill in the art that changes may be made in these embodiments without departing from the principles and spirit of the disclosure, the scope of which is defined in the claims and their equivalents.

What is claimed is:

1. A layered sheet for interior material of vehicles, the layered sheet comprising:
a skin layer including a polyurethane (PU) layer and a polyvinyl chloride (PVC) sheet layer disposed under the PU layer; and
a base layer disposed under the skin layer,
wherein the base layer includes thermoplastic olefin (TPO), polyurethane (PU) foam, or soft-polypropylene (S-PP) foam.

2. The layered sheet of claim 1, further comprising a surface-treated layer on the PU layer.

3. The layered sheet of claim 1, further comprising a backside-treated layer between the skin layer and the base layer.

4. The layered sheet of claim 3, further comprising a bond layer between the backside-treated layer and the base layer.

5. The layered sheet of claim 1, further comprising a primer layer under the base layer.

6. The layered sheet of claim 1, wherein the PU layer has a thickness in a range of 0.03 to 0.2 millimeters (mm).

7. The layered sheet of claim 1, wherein the PVC sheet layer has a thickness in a range of 0.2 to 0.5 millimeters (mm).

8. The layered sheet of claim 1, wherein the skin layer has a tensile strength in a range of 150 to 250 kilogram-force per square centimeter (kgf/cm²).

9. The layered sheet of claim 1, wherein the skin layer has a tensile elongation at a break point of 250% or more.

10. The layered sheet of claim 1, wherein the layered sheet has a tensile strength in a range of 35 to 45 kilogram-force per square centimeter (kgf/cm²).

11. The layered sheet of claim 1, wherein the layered sheet has a tensile elongation at a break point of 200% or more.

12. A method for manufacturing a layered sheet for interior material of vehicles, the method comprising forming a skin layer by:
preparing a polyvinyl chloride (PVC) sheet layer in the form of a film by blending a PVC resin with a plasticizer at a rate in a range of 50 to 100 parts per hundred resin (phr); and
forming a polyurethane (PU) layer by diluting a PU resin with a dimethylformamide (DMF)-free solvent at a rate in a range of 30 to 70 phr and coating the PVC sheet layer with the diluted PU resin.

13. The method of claim 12, further comprising conducting surface treatment on an upper surface of the skin layer.

14. The method of claim 13, further comprising conducting backside treatment on a lower surface of the skin layer.

15. The method of claim 14, further comprising conducting primer treatment on a lower surface of a base layer disposed under the skin layer.

16. The method of claim 15, further comprising conducting bond treatment on the upper surface of the base layer.

17. The method of claim 16, further comprising laminating the layers.

18. The method of claim 12, wherein in the preparing of the PVC sheet layer, the plasticizer comprises a phthalate-based compound and a non-phthalate-based compound.

19. The method of claim 18, wherein the phthalate-based compound comprises dioctyl phthalate (DOP), diisodecyl phthalate (DIDP), or diisononyl phthalate (DINP).

20. The method of claim 18, wherein the non-phthalate-based compound comprises tris(2-ethylhexyl) trimellitate (TOTM).
